(19) United States
(12) Patent Application Publication
(10) Pub. No.: US 2014/0372936 A1
(43) Pub. Date: Dec. 18, 2014

(54) METHOD AND APPARATUS FOR DISPLAYING TAG DATA

(71) Applicant: Tencent Technology (Shenzhen) Company Limited, Shenzhen (CN)

(72) Inventor: Jing Liu, Shenzhen (CN)

(21) Appl. No.: 14/444,579

(22) Filed: Jul. 28, 2014

Related U.S. Application Data
(63) Continuation of application No. PCT/CN2014/073020, filed on Mar. 7, 2014.

(30) Foreign Application Priority Data
Jun. 13, 2013 (CN) 201310233818.3

(51) Int. Cl. G06F 3/0483; G06F 3/0481; G06F 3/0484

(52) U.S. Cl. CPC G06F 3/0483; G06F 3/04842; G06F 3/04812
USPC 715/783

(57) ABSTRACT

The present invention discloses a method for displaying tag data on a browser display interface. According to the present invention, an instruction for acquiring data associated with a data tag of an browser display interface is triggered when it is detected that a pointing device is moved onto the data tag; the data associated with the data tag is acquired in response to the instruction for acquiring the data; and a data browsing interface is generated for the acquired data, and the generated data browsing interface is displayed on the browser display interface on which the pointing device locates. The advantageous effect of the present invention is that the data browsing interface associated with the data tag is displayed on the browser display interface, thereby improving the efficiency of window switching and the convenience of use, and leading to a more intelligent browser.

The present application claims priority to and is a continuation of PCT/CN2014/073020, filed on Mar. 7, 2014 and entitled “METHOD AND APPARATUS FOR DISPLAYING TAG DATA”, which claims the priority to Chinese Patent Application No. 201310233818.3, entitled “METHOD AND APPARATUS FOR DISPLAYING TAG DATA”, filed on Jun. 13, 2013 with State Intellectual Property Office of People's Republic of China, both of which are incorporated herein by reference in entirety.

### TECHNICAL FIELD

The present invention relates to data processing technology and browser technology, and in particular to a method and apparatus for displaying tag data.

### BACKGROUND

In the case that a browser runs and at least one page is opened, the browser can switch to a page corresponding to a page tag for a user to browse only when it is detected by the browser that a mouse cursor is moved onto the page tag and a mouse operation (such as clicking the left button) for switching to the page is performed by the user. During this process, the user can not be informed of specific content in a page corresponding to a data tag if no operation is performed by the cursor even though it is detected by the browser that the mouse cursor is moved onto the data tag such as a page tag or a linked word on a web page or a functionality control on the web page. For example, when the user browses multiple pages which are all opened, the user has to click the page tags one by one to switch among the pages corresponding to the page tags to browse the specific content in each of the pages. This is because the user can not preview the content in the page corresponding to the data tag, such as the page tag, of the browser.

### SUMMARY

In view of this, it is necessary to provide a method and apparatus for displaying tag data to solve the problem that an interface associated with a data tag can not be displayed on a browser display interface.

An embodiment of the present invention provides a method for displaying tag data, including:

triggering an instruction for acquiring data associated with a data tag of a browser display interface when it is detected that a pointing device is moved onto the data tag;

acquiring the data associated with the data tag in response to the instruction for acquiring the data; and

generating a data browsing interface for the acquired data and displaying the generated data browsing interface on the browser display interface on which the pointing device locates.

An embodiment of the present invention further provides an apparatus for displaying tag data, including:

an instruction detection module, configured to trigger an instruction for acquiring data associated with a data tag of a browser display interface when it is detected that a pointing device is moved onto the data tag;

a data acquiring module, configured to acquire the data associated with the data tag in response to the instruction for acquiring the data; and

an interface display module, configured to generate a data browsing interface for the acquired data and display the generated data browsing interface on the browser display interface on which the pointing device locates.

According to the embodiments of the present invention, when it is detected that a pointing device is moved onto a data tag of a browser display interface, data associated with the data tag is acquired, a data browsing interface is generated for the acquired data, and the generated data browsing interface is displayed on the browser display interface on which the pointing device locates. Compared with the prior art that the interface corresponding to the data tag can only be browsed when the interface is switched to, the method according to the embodiments of the present invention is advantageous in that a data browsing interface associated with the data tag is displayed on the browser display interface, thereby improving the efficiency of window switching and the convenience of use, leading to a more intelligent browser and further increasing the man-machine interactivity.

### BRIEF DESCRIPTION OF THE DRAWINGS

FIG. 1 is a schematic flow diagram of a method for displaying tag data according to an embodiment of the present invention;

FIG. 2 is a schematic operational diagram of displaying a page corresponding to a page tag on a browser display interface in the method for displaying the tag data according to an embodiment of the present invention;

FIG. 3 is a schematic flow diagram of a method for displaying the tag data according to another embodiment of the present invention;

FIG. 4 is a schematic operational diagram of displaying a page corresponding to a data access interface tag on the browser display interface in the method for displaying the tag data according to an embodiment of the present invention;

FIG. 5 is a schematic diagram of functional modules in an apparatus for displaying tag data according to an embodiment of the present invention; and

FIG. 6 is a schematic diagram of functional modules in an apparatus for displaying the tag data according to another embodiment of the present invention.

The objects, functional characteristics and advantages of the embodiments of the present invention are further illustrated in conjunction with the embodiments and by reference to the drawings.

### DETAILED DESCRIPTION

The technical solution according to the present invention is further illustrated in conjunction with the drawings and the embodiments of the disclosure. It should be understood that the embodiments described herein are only for explaining the disclosure and are not intended to limit the present disclosure.

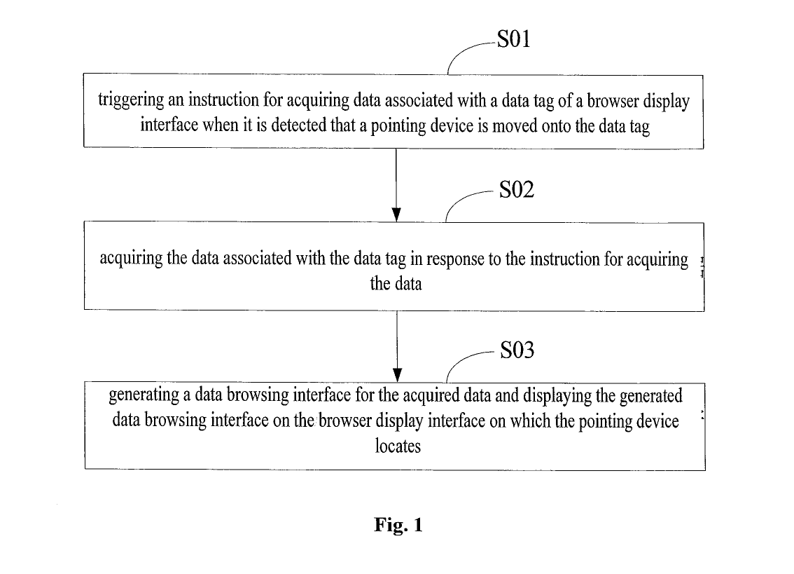

FIG. 1 is a schematic flow diagram of a method for displaying tag data according to an embodiment of the present invention. As shown in FIG. 1, the method for displaying the tag data according to the present invention includes following steps S01 to S03.

Step S01: triggering an instruction for acquiring data associated with a data tag of a browser display interface when it is detected that a pointing device is moved onto the data tag.

In one embodiment, the pointing device may be a cursor, a stylus, a touching object, a finger or the like.

The position of the pointing device on the browser interface is monitored in real time when the browser is started up and is running. The instruction for acquiring the data associated with the data tag of the browser display interface is triggered when it is detected that the pointing device is moved onto the data tag. The data associated with the data tag may include a web page including various web page elements such as words, images, audio and video files.

The data tag may be a page tag, a data access interface tag or a functionality control tag. The page tag may include the tags corresponding to the respective page windows when multiple pages are opened by the browser. The data access interface tag may include linked characters, words or phrases or the like on a web page displayed by the browser, such as linked phrases “Baidu”, “Sina”, “Tencent”, “QQ space”, “Jingdong Mall”, “YHD” or the like displayed on the main page of “www.hao123.com”. The pages corresponding to the foregoing linked phrases may be accessed once the phrases are clicked. Such a character, word or phrase may be referred to as the data access interface tag. The functionality control tag may include functionality controls on the main page displayed by the browser, such as the functionality button “Baidu it” on the main page of “www.hao123.com”.

Step S02: acquiring the data associated with the data tag in response to the instruction for acquiring the data.

The data associated with the data tag is acquired by the browser in response to the instruction for acquiring the data when the instruction for acquiring the data associated with the data tag on which the pointing device locates on the browser display interface is triggered. For example, in the case that the data tag is the page tag, the page corresponding to the page tag is being run on the browser, therefore locally cached data of the page corresponding to the page tag may be acquired by the browser. In the case that the data tag is the functionality control tag, the functionality controls on the page of the browser are fixed (even if the version of the browser may be upgraded, the functionality controls on the page(s) of the upgraded browser are also fixed), therefore the data corresponding to the functionality control may also be acquired by the browser from the locally cached data. Of course, the data corresponding to some functionality controls may also be acquired by the browser from a database stored in a server. In the case that the data tag is the data access interface tag, the data stored in the database pointed by a link address corresponding to the data tag is acquired by the browser.

Step S03: generating a data browsing interface for the acquired data, and displaying the generated data browsing interface on the browser display interface on which the pointing device locates.

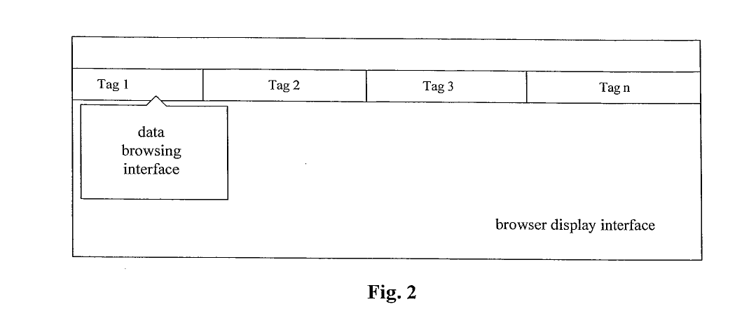

The data browsing interface is generated by the browser according to the acquired data corresponding to the data tag, and the generated data browsing interface is displayed on the browser display interface on which the pointing device locates, so that the user can browse the data browsing interface corresponding to various data tags on the browser display interface on which the pointing device locates without having to switch to the data browsing interface corresponding to the data tags. FIG. 2 is a schematic operational diagram of displaying a page corresponding to a page tag on a browser display interface in the method for displaying the tag data according to an embodiment of the present invention. As shown in FIG. 2, in the case that multiple pages are running on the browser, the page “Baidu” may be displayed on the browser display interface in a form of a small window when the pointing device is moved onto the page tag of the page “Baidu” which is already opened on the browser display interface, thereby avoiding the inconvenience of window switching.

The advantageous effect of the embodiment is particularly significant in the case that the data tag is the page tag. For example, in the case that multiple pages are running on the browser, the user can browse the pages corresponding to the page tags by moving the pointing device onto the page tags without having to click the page tags one by one to switch among the pages corresponding to the page tags.

In a preferable embodiment, acquiring, by the browser, the data associated with the data tag and generating the data browsing interface for the acquired data includes the following steps. A system screenshot program is invoked by the browser to capture a picture of the page constructed by the locally cached data corresponding to the data tag, and the captured picture is displayed on the browser display interface on which the pointing device locates, for the user to browse. A picture of a blank page is captured and displayed in the case that the locally cached data corresponding to the data tag can not construct a page.

In a preferable embodiment, displaying the generated data browsing interface on the browser display interface on which the pointing device locates includes displaying the data browsing interface in a form of a small floating window. The small floating window may be set to be translucent. Those of ordinary skilled in the art may appreciate that the specific display forms such as the shape, size and transparency of the data browsing interface are not limited herein, as long as the browser can pop-out the data browsing interface corresponding to a data tag when the pointing device is moved onto the data tag.

According to the embodiments of the present invention, an instruction for acquiring data associated with a data tag of the browser display interface is triggered when it is detected that a pointing device is moved onto the data tag; the data associated with the data tag is acquired in response to the instruction for acquiring the data; a data browsing interface is generated for the acquired data and the generated data browsing interface is displayed on the browser display interface on which the pointing device locates. The method displaying the tag data according to the embodiment of the present invention is advantageous in that the data browsing interface associated with the data tag is displayed on the browser display interface, thereby rendering the browser to be more intelligent.

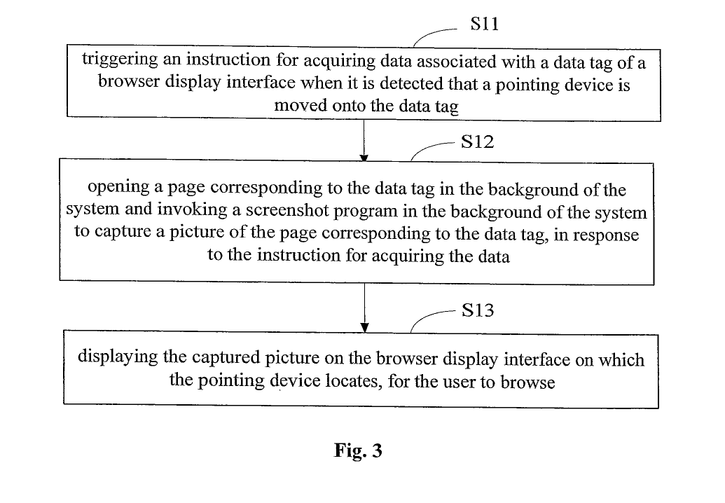

FIG. 3 is a schematic flow diagram of the method for displaying the tag data according to another embodiment of the present invention. This embodiment differs from the first embodiment in Step S12 and Step S13 and therefore detailed description is made only for Step S12 and Step S13 in this embodiment. For other steps related to the method for displaying the tag data according to the present disclosure, the specific description of relevant embodiment may be referred to, which are not described herein. As shown in FIG. 3, the method for displaying the tag data according to an embodiment of the present invention further includes following steps S11 to S13.

Step S11: triggering an instruction for acquiring data associated with a data tag of a browser display interface when it is detected that a pointing device is moved onto the data tag.

Step S12: opening a page corresponding to the data tag in the background of the system and invoking a screenshot program in the background of the system to capture a picture of the page corresponding to the data tag, in response to the instruction for acquiring the data.

The instruction for acquiring the data associated with the data tag is triggered when it is detected by the browser that the pointing device is moved onto the data tag of the browser display interface. In response to the instruction for acquiring the data, the page corresponding to data tag is opened in the background of the system by the browser, and a screenshot program in the background of the system is simultaneously invoked to capture a picture of the page which is associated with the data tag and is opened in the background.

The specific implementation for the browser to invoke a screenshot program in the background of the system is not limited herein, as long as the browser can capture the picture of the page which is associated with the data tag and is opened in the background.

Step S13: displaying the captured picture on the browser display interface on which the pointing device locates, for the user to browse.

The captured picture is displayed by the browser on the browser display interface on which the pointing device locates for the user to browse without having to switch to the page corresponding to the data tag.

In a preferable embodiment, displaying the captured picture on the browser display interface on which the pointing device locates includes displaying, in a form of a small floating window, the page picture scaled down with a predetermined proportion. For example, the captured picture may be scaled down in a proportion of 1:6 to be displayed. The small floating window may be set to be translucent. Those of ordinary skilled in the art may appreciate that the specific display forms such as the shape, size and transparency of the picture are not limited herein, as long as the picture of the page corresponding to a data tag can be pop out by the browser when the pointing device is moved onto the data tag.

The advantageous effect of the embodiment is particularly significant in the case that the data tag is the data access interface tag. For example, the page corresponding to the linked word on the main page of the browser may be displayed when the pointing device is moved onto the linked word without having to click the data access interface tags one by one to switch among the pages corresponding to the data access interface tags.

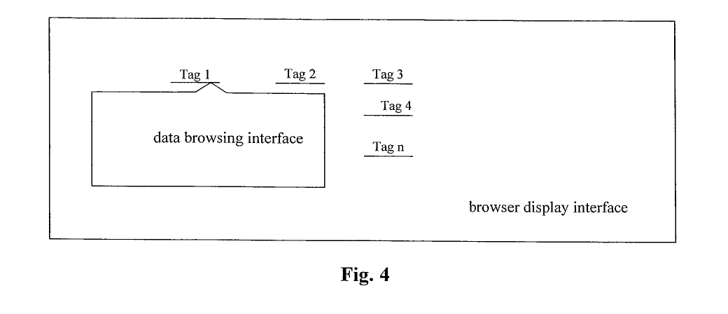

FIG. 4 is a schematic operational diagram of displaying a page corresponding to a data access interface tag on the browser display interface in the method for displaying the tag data according to an embodiment of the present invention. As shown in FIG. 4, the main page of “www.hao123.com” is taken as an example. When the pointing device is moved onto the data access interface tag such as “Baidu” on the main page of “www.hao123.com” displayed by the browser, the page “Baidu” can be displayed by the browser in a form of a small window on the current display interface, thereby avoiding the inconvenience of jumping to the page corresponding to the linked word.

According to the embodiments of the present invention, when it is detected that a pointing device is moved onto the data tag of a browser display interface, the browser invokes a screenshot program in the background of the system to capture a picture of a page corresponding to the data tag and displays the captured picture on the browser display interface on which the pointing device locates, thereby avoiding the inconvenience of page jumping, further improving the efficiency of window switching in the browser and the convenience of use, increasing the man-machine interactivity and leading to a more intelligent browser.

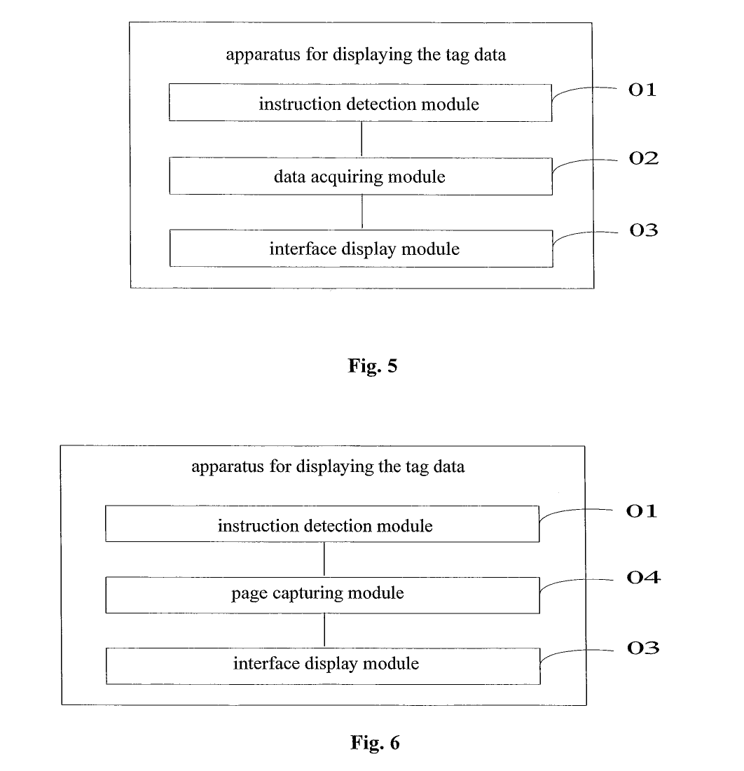

FIG. 5 is a schematic functional module diagram of an apparatus for displaying tag data according to an embodiment of the present invention. As shown in FIG. 5, the apparatus for displaying the tag data according to the present invention includes: an instruction detection module 01, a data acquiring module 02 and an interface display module 03.

The instruction detection module 01 is configured to trigger an instruction for acquiring data associated with a data tag of a browser display interface when it is detected that a pointing device is moved onto the data tag.

The instruction detection module 01 monitors the position of the pointing device on the browser interface in real time when the browser is started up and is running, and triggers the instruction for acquiring the data associated with the data tag of the browser display interface when it is detected that the pointing device is moved onto the data tag. The data associated with the data tag may include a web page including various web page elements such as words, images, audio and video files.

The data tag may be a page tag, a data access interface tag or a functionality control tag. The page tag may include the tags corresponding to the respective page windows when multiple pages are opened by the browser. The data access interface tag may include linked characters, words or phrases or the like on a web page displayed by the browser, such as linked phrases “Baidu”, “Sina”, “Tencent”, “QQ space”, “Jingdong Mall”, “YHD” or the like displayed on the main page of “www.hao123.com”. The pages corresponding to the foregoing linked phrases may be accessed once the phrases are clicked. Such a character, word or phrase may be referred to as the data access interface tag. The functionality control tag may include functionality controls on the main page displayed by the browser, such as the functionality button “Baidu it” on the main page of “www.hao123.com”.

The data acquiring module 02 is configured to acquire the data associated with the data tag in response to the instruction for acquiring the data.

The data acquiring module 02 acquires the data associated with the data tag in response to the instruction for acquiring the data when it is detected by the instruction detection module 01 that the instruction for acquiring the data associated with the data tag on which the pointing device locates on the browser display interface is triggered. For example, in the case that the data tag is the page tag, the page corresponding to the page tag is being run on the browser, therefore the data acquiring module 02 may acquire locally cached data of the page corresponding to the page tag. In the case that the data tag is the functionality control tag, the functionality controls on the page of the browser are fixed (even if the version of the browser may be upgraded, the functionality controls on the page(s) of the upgraded browser are also fixed), therefore the data acquiring module 02 may also acquire the data corresponding to the functionality control from the locally cached data. Of course, the data acquiring module 02 may also acquire the data corresponding to some functionality controls from a database stored in a server. In the case that the data tag is the data access interface tag, the data acquiring module 02 acquires the data stored in the database pointed by a link address corresponding to the data tag.

The interface display module 03 is configured to generate a data browsing interface for the acquired data and display the generated data browsing interface on the browser display interface on which the pointing device locates.

The interface display module 03 generates the data browsing interface corresponding to the data tag according to the data corresponding to the data tag acquired by the data acquiring module 02, and displays the generated data browsing interface on the browser display interface on which the pointing device locates, so that the user can browse the data browsing interface corresponding to various data tags described above on the browser display interface on which the pointing device locates without having to switch to the data browsing interface corresponding to the data tags. As shown in FIG. 2, in the case that multiple pages are running on the browser, the interface display module 03 may display the page “Baidu” on the browser display interface in a form of a small window when the pointing device is moved onto the page tag of the page “Baidu” which is already opened on the browser display interface, thereby avoiding the inconvenience of window switching of the page to be browsed.

The advantageous effect of the embodiment is particularly significant in the case that the data tag is the page tag. For example, in the case that multiple pages are running on the browser, the user can browse the pages corresponding to the page tags by moving the pointing device onto the page tags without having to click the page tags one by one to switch among the pages corresponding to the page tags.

In a preferable embodiment, generating, by the interface display module 03, the data browsing interface for the acquired data according to the data associated with the data tag acquired by the data acquiring module 02 includes the following process. The interface display module 03 invokes a system screenshot program to capture a picture the page constructed by the locally cached data corresponding to the data tag, and displays the captured picture on the browser display interface on which the pointing device locates, for the user to browse. A picture of a blank page is captured and displayed by the interface display module 03 in the case that the locally cached data corresponding to the data tag can not construct a page.

In the preferable embodiment, displaying, by the interface display module 03, the generated data browsing interface on the browser display interface on which the pointing device locates includes displaying the data browsing interface in a form of a small floating window. The small floating window may be set to be translucent. Those of ordinary skilled in the art may appreciate that as long as the browser can pop-out the data browsing interface corresponding to a data tag when the pointing device is moved onto the data tag, the specific display forms such as the shape, size and transparency of the data browsing interface are not limited herein.

According to the embodiments of the present invention, an instruction for acquiring data associated with a data tag of the browser display interface is triggered when it is detected that a pointing device is moved onto the data tag; the data associated with the data tag is acquired in response to the instruction for acquiring the data; a data browsing interface is generated for the acquired data, and the generated data browsing interface is displayed on the browser display interface on which the pointing device locates. The apparatus for displaying the tag data according to the embodiments of the present invention is advantageous in that the data browsing interface associated with the data tag is displayed on the browser display interface, thereby rendering the browser to be more intelligent.

FIG. 6 is a schematic functional module diagram of an apparatus for displaying the tag data according to another embodiment of the present invention. This embodiment differs from the embodiment described in FIG. 5 in that the data acquiring module 02 is replaced with a page capturing module 04. The specific description is made only for the page capturing module 04, for other functional modules related to the apparatus for displaying the tag data according to the present invention, the specific description of relevant embodiment may be referred to, which are not described herein.

As shown in FIG. 6, the apparatus for displaying the tag data according to the present invention further includes:

a page capturing module 04, configured to open a page corresponding to the data tag in the background of the system and invoke a screenshot program in the background of the system to capture a picture of the page corresponding to the data tag, in response to the instruction for acquiring the data.

The instruction for acquiring the data associated with the data tag is triggered when it is detected by the instruction detection module 01 that the pointing device is moved onto the data tag of the browser display interface. In response to the instruction for acquiring the data, the page capturing module 04 opens the page corresponding to data tag in the background of the system, and simultaneously invokes a screenshot program in the background of the system to capture a picture of the page which is associated with the data tag and which is opened in the background associated with the data tag.

The specific implementation for the page capturing module 04 to invoke a screenshot program in the background of the system is not limited herein, as long as the browser can capture the picture of the page which is associated with the data tag and is opened in the background and obtain the captured page picture.

The interface display module 03 displays the captured picture on the browser display interface on which the pointing device locates, for the user to browse without having to switch to the page corresponding to the data tag.

In a preferable embodiment, displaying, by the interface display module 03, the captured picture on the browser display interface on which the pointing device locates includes displaying, in a form of a small floating window, the page picture scaled down with a predetermined proportion. For example, the captured picture may be scaled down in a proportion of 1:6 to be displayed. The small floating window may be set to be translucent. Those of ordinary skilled in the art may appreciate that the specific display forms such as the shape, size and transparency of the picture are not limited herein, as long as the interface display module 03 can pop-out the page picture corresponding to a certain data tag when the pointing device is moved onto the data tag.

The advantageous effect of the embodiment is particularly significant in the case that the data tag is the data access interface tag. For example, the interface display module 03 may display the page corresponding to the linked word on the main page of the browser when the pointing device is moved onto the linked word without having to click the data access interface tags one by one to switch among the pages corresponding to the data access interface tags.

As shown in FIG. 4, the main page of “www.hao123.com” is taken as an example. When the pointing device is moved onto the data access interface tag such as “Baidu” on the main page of “www.hao123.com” displayed by the browser, the interface display module 03 can display the page “Baidu” in a form of a small window on the current display interface, thereby avoiding the inconvenience of jumping to the page corresponding to the linked word.

According to the embodiments of the present invention, when it is detected that a pointing device is moved onto the data tag of a browser display interface, the browser invokes a screenshot program in the background of the system to capture a picture of a page corresponding to the data tag, and displays the captured picture on the browser display interface on which the pointing device locates, thereby avoiding the inconvenience of page jumping, further improving the efficiency of window switching in the browser and the convenience of use, increasing the man-machine interactivity and leading to a more intelligent browser.

It should be noted that, the terminologies of “comprise”, “include”, and any other variants are intended to cover the non-exclusive inclusion. Therefore, the process, method, article or device including a series of elements includes not only those elements but also other elements that are not enumerated, or also include the elements inherent for the process, method, article or device. In the case of no additional restrictions, the statement “comprising (including) one . . . ” does not exclude that the case that other elements also exist in the process, method, article or device.

Serial numbers of the embodiments are only for illustration, merits of the embodiments may not be reflected by the serial numbers.

According to the description of the above embodiments, those of ordinary skilled in the art may recognize that the above embodiments of the method may be implemented by software and a necessary universal hardware platform, and the above embodiments of the method may also be implemented by hardware, the former is preferable in many cases. On the basis of this understanding, the technical principle of the present disclosure or the part of the present disclosure contributing to the existing technologies may be embodied in a form of a software product which is stored in a storage medium (such as ROM/RAM, disk or CD). The software product may include a plurality of instructions for instructing a terminal device (which may be a mobile phone, a computer, a server, a network equipment or the like) to perform the methods described in the embodiments of the present invention.

The described embodiments are merely preferred embodiments of the disclosure. The embodiments are not intended to limit the disclosure. Any change, equivalent replacement, direct or indirect application in other related technical fields, etc., without departing from the spirit and principle of the disclosure should fall in the scope of protection of the disclosure.

What is claimed is:

1. A method for displaying tag data, comprising:
triggering, by a device comprising a processor, an instruction to acquire data associated with a tag on a browser display interface when a pointing device is moved onto the tag;
acquiring, by the device, the data associated with the tag;
generating, by the device, a data browsing interface for the acquired data; and
displaying the generated data browsing interface on the browser display interface.

2. The method according to claim 1, wherein acquiring the data associated with the tag comprises:
acquiring cached data associated with the tag.

3. The method according to claim 1, wherein acquiring the data associated with the tag comprises:
acquiring data stored in a database associated with a link address corresponding to the tag.

4. The method according to claim 1, wherein the data associated with the tag comprises at least one of words, images, audio and videos.

5. The method according to claim 1, further comprising:
capturing a picture of a page corresponding to the tag, in response to the instruction to acquire the data; and
displaying the captured picture on the browser display interface on which the pointing device locates.

6. The method according to claim 5, wherein displaying the captured picture comprises:
displaying, in a form of a floating window, the captured picture at a predetermined proportion.

7. The method according to claim 6, wherein the floating window is translucent.

8. The method according to claim 1, wherein the tag comprises at least one of:
a page tag, a data access interface tag, and a functionality control tag.

9. The method according to claim 1, wherein the tag comprises a data access interface tag, and wherein the data access interface tag comprises at least one of characters, words, and phrases.

10. The method according to claim 1, wherein the pointing device comprises at least one of a cursor, a stylus, a touching object and a finger.

11. A method for displaying tag data, comprising:
triggering, by a device comprising a processor, an instruction to acquire data associated with a tag on a browser display interface when a pointing device is moved onto the tag;
opening, by the device, a page corresponding to the tag;
invoking, by the device, a screenshot program to capture a picture of the page corresponding to the tag; and
displaying, by the device, the captured picture on the browser display interface.

12. The method according to claim 11, wherein the captured picture is displayed, in a form of a floating window, at a predetermined proportion.

13. An apparatus for displaying tag data, comprising:
an instruction detection module comprising a processor, configured to trigger an instruction to acquire data associated with a tag on a browser display interface when a pointing device is moved onto the tag;
a data acquiring module comprising a processor, configured to acquire the data associated with the tag in response to the instruction to acquire the data; and
an interface display module comprising a processor, configured to generate a data browsing interface for the acquired data and display the generated data browsing interface on the browser display interface.

14. The apparatus according to claim 13, wherein the data acquiring module is further configured to:
acquire cached data associated with the data tag.

15. The apparatus according to claim 13, wherein the data acquiring module is further configured to:
acquire data stored in a database associated with a link address corresponding to the tag.

16. The apparatus according to claim 13, wherein the apparatus further comprises a page capturing module, configured to capture a picture of a page corresponding to the tag, in response to the instruction to acquire the data.

17. The apparatus according to claim 16, wherein the interface display module is further configured to display the captured picture on the browser display interface.

18. The apparatus according to claim 13, wherein the interface display module is further configured to display, in a form of a floating window, the captured picture at a predetermined proportion.

19. The apparatus according to claim 13, wherein the tag comprises at least one of:
a page tag, a data access interface tag, and a functionality control tag.
